(19) United States
(12) Patent Application Publication
(10) Pub. No.: US 2026/0218766 A1
(43) Pub. Date: Jul. 30, 2026

(54) ENCAPSULATED BRAKE SYSTEM COMPRISING COOLING CONDUCTORS AND A LINEAR DRIVE

(71) Applicant: Schaeffler Technologies AG & Co. KG, Herzogenaurach (DE)

(72) Inventors: Doris Maria Wimmer, Ottenhöfen (DE); Simon Ortmann, Pulheim (DE); Benedikt Grubauer, Neresheim (DE); Alan Barrera Bohorquez, Karlsruhe (DE)

(21) Appl. No.: 19/137,217

(22) PCT Filed: Nov. 8, 2023
(86) PCT No.: PCT/DE2023/100836

§ 371 Date: Jun. 9, 2025

(30) Foreign Application Priority Data
Dec. 9, 2022 (DE) 102022132761.2

(51) Int. Cl. F16D 65/853; F16D 55/32

(52) U.S. Cl. CPC F16D 65/853; F16D 55/32

(57) ABSTRACT

The invention relates to a brake assembly for an axle to be braked, said brake assembly containing: a housing that encloses an interior; a main body; a rotatably mounted shaft that extends at least partially in the interior and has a connecting flange for the axle; an axially displaceable brake disc that is mounted on the shaft for conjoint rotation therewith; a first braking surface against which the brake disc can be axially pressed; a second axially movable braking surface on the other side of the brake disc; a wedge gear in order to press the second braking surface against the brake disc and thus the brake disc against the first braking surface; and a cooling conductor in order to dissipate heat generated during braking from the two braking surfaces.

### CROSS-REFERENCE TO RELATED APPLICATION

The present application is the U.S. National Phase of PCT Patent Application Number PCT/DE 2023/100836, filed on Nov. 8, 2023, which claims priority to German Patent Application Number 10 2022 132 761.2, filed Dec. 9,2022, the entire disclosures of which are incorporated by reference herein.

### TECHNICAL FIELD

The present disclosure relates to the braking of a rotating axle, in particular a drive axle in an automobile, in particular in a BEV (battery electric vehicle), in particular therefore the braking of an automobile.

### BACKGROUND

It is common practice to use a conventional disc brake to slow down an axle. The axle is coupled to a brake disc so that it cannot rotate. When braking is required, the brake pads rub against the brake disc to slow down the axle.

### SUMMARY

The purpose of the present disclosure is to provide improvements with regard to the braking of an axle.

This object is achieved by a brake assembly according to claim 1. Preferred or advantageous embodiments of the disclosure as well as other categories of the disclosure arise from the other claims, the following description, and the appended figures.

The brake assembly serves or is set up for an axle to be braked, i.e., for braking the rotation of the axle about its central longitudinal axis. In particular, the axle is part of a vehicle's chassis/drive train. For example, it is a driven or non-driven wheel axle or an axle that is rotationally coupled thereto. Coupling can take place, for example, via additional axles, gearboxes, clutches, etc. The braking system slows down the axle, i.e., applies a braking torque to the axle. In particular, the axle is that of a battery electric vehicle.

The brake assembly contains a housing. The housing encloses an interior. The brake assembly contains a main body This forms a mechanical support or base structure for the rest of the brake assembly and is firmly connected to a vehicle part, for example, to absorb or discharge the braking torque of the axle.

The brake assembly contains a shaft. The shaft is mounted on the main body so that it can rotate about its central longitudinal axis and, in particular, is fixed to the main body in the axial direction. The shaft extends at least partially in the interior. The shaft has a connecting flange. This is accessible on the outside of the housing and is connected to the axle for conjoint rotation in at least one desired direction of brake rotation. In other words, the drive axle can be coupled to the shaft in a rotationally fixed manner via the connecting flange, at least for transmitting a braking torque from the brake assembly to the drive axle. “Has” is therefore to be understood broadly and includes any type of coupling in relation to the braking torque.

The connecting flange can therefore also be indirectly connected to the shaft, for example via a deflection, a transmission gear, etc. In the simplest case, however, the shaft itself in particular has the connecting flange directly. This means that the connecting flange is a flange end of the shaft.

The brake assembly contains a brake disc. The brake disc is located in the interior and is axially displaceable relative to the main body. “Axial” refers to the central longitudinal axis/axis of rotation of the shaft and brake disc. The brake disc is also mounted for conjoint rotation on the shaft. The decisive factor here is the axial displaceability of the brake disc in relation to the main body. This can be achieved by the brake disc being axially fixed on the shaft itself and being axially displaceable together with the shaft in the main body or relative thereto. In particular, however, the shaft is mounted axially fixed in the main body and the brake disc is mounted so as to be axially displaceable on/relative to the shaft.

The main body has a first braking surface in the interior. Due to its axial displaceability, the brake disc can be lifted towards the braking surface and away therefrom. A surface normal of the generally flat braking surface therefore points in the axial direction. The brake disc is brought into contact with the braking surface by its above-mentioned axial displacement relative to the main body, in particular on the shaft or opposite or relative to the shaft.

The braking system contains a second braking surface. Seen in the axial direction, this lies beyond the brake disc with respect to the first braking surface, i.e., on its other flat side. In addition, the second braking surface is movably mounted or displaceable in the axial direction relative to the main body. The surface normal of the second-usually also flat-braking surface also points in the axial direction, but in the opposite direction to the surface normal of the first braking surface. In other words, the two braking surfaces are arranged opposite or on both sides of the brake disc and face each other to enclose the brake disc therebetween in a pincer-like manner. In other words, according to the brake assembly, the brake disc is frictionally clamped between the first and second braking surfaces during the braking process.

The brake assembly contains a linear drive. This engages between the main body and the second braking surface, i.e., it causes the second braking surface to move relative to the main body. The linear drive is designed to move the second braking surface in an axial direction relative to the main body against the brake disc (or away therefrom). By applying pressure to the brake disc in the axial direction towards the first braking surface, the linear drive is also set up to move the brake disc in the axial direction against the first braking surface, i.e., by axially displacing the entire brake disc.

The linear actuator is driven in the axial direction, in particular exclusively in the axial direction. In other words, a drive or actuator acts on the second braking surface in the axial direction to drive or move it. In particular, the linear drive is also set up to actively move the second braking surface in the opposite direction, i.e., away from the brake disc. In particular, there is also a return means to lift the brake disc axially from the first braking surface, e.g., by spring force. This creates clearance on both sides of the brake disc to both braking surfaces if no braking effect is desired. However, a resetting agent is not absolutely necessary: If the counter-material disc is pulled back from the brake disc by a linear drive in the form of an electromechanical actuator, for example, the brake disc also rotates freely due to its rotation.

The brake assembly contains a cooling conductor. The cooling conductor is in particular a cooling channel through which a coolant can flow. The heat sink is designed to absorb heat from its surroundings and transport it away therefrom. The cooling conductor is thermally coupled to at least both braking surfaces and is designed to dissipate heat generated on the braking surfaces (and the brake disc) during braking of the rotating brake disc, at least from the two braking surfaces or from the surroundings of the braking surfaces (housing/main body). “At least” means that the cooling conductor can also be thermally coupled with other parts/regions of the brake assembly/housing/main body, so that heat can also be dissipated therefrom. Braking is the process when the braking surface and brake disc rub against each other. The heat generated is the corresponding frictional heat. “The cooling conductor” within the meaning of the present application can have several partial sections or “the cooling conductor” can also be several individual cooling conductors, which dissipate heat from the two braking surfaces or other points of the brake assembly accordingly.

In particular, several individual first and second braking surfaces are also possible, each of which is opposite the brake disc in the axial direction. The brake disc is then braked at several points.

In particular, the linear drive or part thereof is as thermally conductive as possible to conduct heat away from the second braking surface to a remote location where the heat can then be dissipated by the cooling conductor. In other words, heat flows from the second braking surface via (part of) the linear drive to the cooling conductor during braking.

The disclosure is based on the following considerations:

It can be assumed that future legislation will provide for a limit on particulate matter pollution from cars. A solution is therefore being sought to prevent the emission of brake dust particles into the environment. At the same time, it is desirable to use the waste heat from braking in a system such as an automobile. In the automobile, for example, a range extension or efficiency increase can be achieved. This is achieved by the fact that no or less heat needs to be generated in the vehicle through the conversion of electrical or other necessary energy. Heat is required, for example, to heat the traction battery of an electric vehicle (BEV), to preheat the traction electric motor or to heat a passenger compartment.

The disclosure is also based on the realization that these considerations are not only applicable to automobiles or their drive train/chassis, but to any axles, drive trains or drive axles which might need to be braked. The corresponding disclosure concept can therefore be applied to any axle to be braked, but in particular to drive or drive axles in an electric motor-driven electric vehicle.

According to the disclosure, it is possible to reduce the brake dust emission for the axle to be braked, see below the encapsulation by the housing. It is also possible to increase system efficiency in the system with the axle/brake assembly by making the heat dissipated from the brake assembly during braking available and usable at the cooling line.

In particular, the heat generated in an electric vehicle can also be used when the battery is “full”. Alternatively, braking power/braking energy converted into electrical energy by a brake generator could no longer be stored electrically.

According to the disclosure, the brake assembly is attached to an axle, for example a drive train of an electric vehicle, as a supplementary braking system. The axle can be the drive axle or a vehicle axle without drive. The brake assembly then supplements recuperation of the electric motor in particular in driving situations in which recuperation cannot absorb all or any of the braking energy. These are, for example, driving situations with low speed/engine speed or stopping to a standstill or braking at low temperatures. The advantage of an additional (encapsulated) brake (i.e., the braking system) is that the braking energy can be transferred as heat to an in-system thermal management (without the energy needing to be stored in the battery in the meantime). In addition, with encapsulation, brake dust particles are not released into the environment.

The brake assembly is a disc brake system in which the rotating brake disc is axially displaceably mounted on the shaft, in particular on a toothing. The brake disc is pressed axially against the housing (main body, first braking surface) in particular with the aid of a counter-material disc (especially with a second braking surface, see below), which is actuated axially. In (under) this body and the friction surface to the housing (first braking surface), cooling channels are provided in particular (generally: cooling conductors) through which a cooling liquid flows and which are connected to the cooling circuit of a thermal management system, for example.

According to the disclosure, the result is in particular an encapsulated, supplementary braking system, axially actuated, with cooling channels in the housing.

In a preferred embodiment, at least a partial section of the cooling conductor, in particular the entire cooling conductor, is embedded in the main body. In particular, these are recesses/holes/cut-outs, etc., in the main body. In other words, the cooling conductor extends inside the main body. In particular, this extends in a heat path that is thermally favorably coupled to the braking surfaces, especially in the vicinity of both or at least one of the braking surfaces. This means that heat generated on the braking surfaces during the braking process can be dissipated particularly effectively through the cooling conductor and reused.

In a preferred embodiment, at least a partial section of the cooling conductor, in particular the entire cooling conductor, therefore extends in the region of the first braking surface. “In the region” is to be understood in such a way that it extends as close or as close as possible to or under the braking surface in a body that has the braking surface, e.g., the main body. This means that the cooling conductor is placed so close to/“under” the braking surface that the strength requirements of the body are just about sufficiently fulfilled to ensure sufficient mechanical stability of the body or the braking surfaces.

In a preferred embodiment, the first and/or second braking surface extends in the circumferential direction completely annularly around the central longitudinal axis. In particular, the second braking surface is part of the surface of an axially displaceable counter-material disc of the linear drive that is rotationally fixed to the main body in the circumferential direction. In other words, the remaining linear drive is used to press the counter-material disc against the brake disc. In particular, the first and second braking surface is therefore a circular ring concentric to the central longitudinal axis and in a plane transverse to the central longitudinal axis. The displacement of the second braking surface is effected by an actual drive/actuator of the linear actuator.

In a preferred embodiment, at least a partial section of the cooling conductor is arranged on-in particular in/within-a section of the linear drive that can move relative to the main body. This section can be, for example, a movable pressure piston of a hydraulic linear drive and/or the above-mentioned counter-material disc. Here, heat can be dissipated particularly effectively from the second braking surface.

In a preferred variant of this embodiment, at least a partial section of the cooling conductor is therefore arranged on-in particular in/within-a counter-material disc of the linear drive that has the second braking surface. In other words, the cooling conductor is located inside the linear drive/counter-material disc.

In a preferred embodiment, the linear drive is actuated hydraulically, in particular exclusively hydraulically. This means, for example, that there is no need for separate electrics/servomotors etc. It can be advantageous to use a hydraulic system with several pistons, particularly if the second braking surface is pressed against the brake disc over the entire surface (second braking surface extends completely in the circumferential direction around the central longitudinal axis, e.g., in the form of a circular ring).

In a preferred embodiment, the housing is designed to be dust-tight in relation to an exterior space surrounding the housing with regard to brake dust. In other words, this prevents brake dust from leaving the brake assembly or the housing. Brake dust is generated, for example, by abrasion of the brake disc or the material on the brake surfaces, especially brake pads.

In a preferred embodiment, the main body is at least a part of the housing or vice versa (housing is at least a part of the main body). In particular, the housing and main body are identical. The housing therefore also serves in particular as a mechanical frame/holder/support for the rest of the brake assembly.

In a preferred embodiment, the brake assembly contains at least one—in particular replaceable—brake lining. Thus the following applies: At least one of the brake linings is part of the main body. In other words, part of the main body is designed as a brake lining. The brake lining thus forms the first braking surface or at least part of the first braking surface. In other words, for example, a brake lining is arranged on the main body, but is understood as part of the main body for the purposes of the application. The corresponding brake lining is designed as a brake pad, for example, which can also be replaceable so that it can be substituted when worn, for example.

Alternatively or additionally, at least one of the brake linings has the second braking surface or forms at least part of the second braking surface. In particular, the brake lining is designed as the aforementioned counter-material disc or part thereof. In other words, the counter-material disc in particular has the brake lining or the brake lining is part of the counter-material disc. As above, the unit comprising the brake lining and the actual counter-material disc is therefore understood as a “counter-material disc” within the meaning of the present application.

Alternatively or additionally, at least one of the brake linings is part of the brake disc and is designed to bear against the first and/or second braking surface. Here, too, the brake lining is applied to an actual brake disc, for example, but is to be understood as part of the brake disc for the purposes of the disclosure. Brake linings on the brake disc in particular can be designed to be thermally insulating or as thermally poorly conductive as possible. The heat generated during braking is therefore discharged as little as possible to the disc, but is instead discharged to the first/second braking surface and can be removed therefrom via the cooling conductor. This minimizes the thermal load on the brake disc.

### BRIEF DESCRIPTION OF THE DRAWINGS

Further features, effects, and advantages of the disclosure are derived from the following description of a preferred exemplary embodiment of the disclosure and the attached figures. In each case, a schematic principle sketch is shown:

FIG. 1 shows a cross-section of a brake assembly,

FIG. 2 shows a section of an alternative brake assembly as shown in FIG. 1.

### DESCRIPTION OF EMBODIMENTS

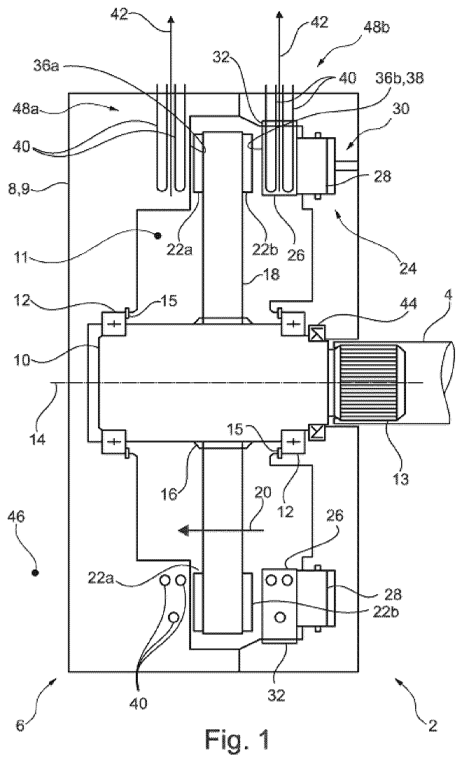

FIG. 1 shows a section of a vehicle 2, in this case a battery electric vehicle in the form of a passenger car. Only one axle 4 and one brake assembly 6 of the vehicle 2 are shown. The axle 4 is a driving axle (motorized or not), which is connected to the wheels of the vehicle 2 in a torque connection. The axle 4 can be braked to slow down the vehicle 2.

The brake assembly 6 is used to brake the axle 4. The brake assembly 6 contains a housing 8. The brake assembly 6 has a main body 9, which is formed here by the housing 8. The housing 8 is therefore identical to the main body 9. The main body is therefore at least one part, namely the mechanically load-bearing part of the housing 8. The main body 9 forms a mechanically stable base frame for the rest of the brake assembly 6 to absorb the braking forces generated during braking. For this purpose, the main body 9 is firmly attached to a frame of the vehicle 2, which is not shown. The housing 8 encloses an interior 11 of the brake assembly 6.

A shaft 10 of the brake assembly 6 is mounted on the housing 8 and on the main body 9 by means of bearings 12. The shaft 10 can be rotated about its central longitudinal axis 14 relative to the housing 8/main body 9, but is fixed in the axial direction of the central longitudinal axis 14. Securing rings 15 secure or hold the bearings 12.

The shaft 10 is connected for conjoint rotation to the axle 4 and thus to the drive or the wheels of the vehicle 2. For this purpose, it has a connecting flange 13 that is accessible outside the housing 8. The shaft 10 has a toothing 16 in the interior 11. The shaft 10 therefore represents a connection of the brake assembly 6 in the direction of the drive.

The brake assembly 6 also contains a brake disc 18 in the interior 11. The brake disc 18 is mounted on the toothing 16 or by means thereof on the shaft 10, so that both are connected to each other for conjoint rotation. However, the brake disc 18 is displaceable in the axial direction (in and against the direction of the arrow 20) on the shaft 10 and thus within the housing 8 or relative to the housing 8. A braking torque applied to the brake disc 18 can therefore be transmitted to the vehicle 2 or its wheels/engine via the toothing 16, shaft 10, connecting flange 13, and axle 4. Axial movement of the brake disc 18 on the shaft 10 is therefore permitted. A brake lining 22a, b is mounted radially on the outside of the brake disc 18 on both flat sides, i.e., in the axial direction, and extends as a circular ring in the circumferential direction around the central longitudinal axis 14. For the purposes of the application, the brake lining 22a, b is considered to be part of the brake disc 18. The brake disc 18 is therefore a rotating, axially displaceable disc. The brake linings 22a, b are therefore friction linings. The toothing 16 is therefore arranged between the brake disc 18 and the shaft 10 and is used to transmit the braking torque.

The brake assembly 6 also includes a linear drive 24. This contains a counter-material disc 26 as well as a hydraulic cylinder 28 arranged or mounted in a displaceable manner in the main body 9. The counter-material disc 26 can be moved (in or against the direction of the arrow 20) via a purely hydraulic drive 30 and the hydraulic cylinder 28, which moves purely in the radial direction with respect to the central longitudinal axis 14. The counter-material disc 26 performs a movement that only includes an axial component. The drive 30 is therefore an actuating unit. The counter-material disc 26 assumes the function of a brake pad here:

When the drive 30 is actuated, the counter-material disc 26 moves in the direction of the arrow 20. As a result, the counter-material disc 26 approaches the brake lining 22b in the axial direction or in the direction of the arrow 20. As a result, a clearance between the counter-material disc 26 and the brake lining 22b or the brake disc 18 is used up. During a further movement in the direction of arrow 20, the counter-material disc 26 also pushes the entire brake disc 18 relative to the shaft 10 in the direction of arrow 20 until the brake lining 22a or the brake disc 18 comes into contact with a first braking surface 36a on the main body 9 or is pressed/rubs thereagainst in a braking manner.

A section of a surface 38 of the counter-material disc 26 acts as a second braking surface 36b, which also rubs against the brake disc 18 (its brake lining 22b) in a braking manner. In other words, the clearance between brake disc 18 and main body 9 is also used up. Further movement of the counter-material disc 26 in the direction of the arrow 20 increases the frictional pressure on the braking surfaces 36a, b and increases the braking effect of the brake assembly 6, i.e., the shaft 10 and thus the axle 4 is braked more and more. The second braking surface 36b is therefore a surface section of the counter-material disc 26 facing the brake disc 18.

To transfer the braking force to the housing 8 or the main body 9, the counter-material disc 26 is axially displaceable in or against the arrow 20 via a guide 32 in the form of a further toothing, but is fixed in rotation in the circumferential direction.

The braking surfaces 36a, b are arranged in the interior 11. The second braking surface 36b is therefore located beyond the brake disc 18 with respect to the first braking surface 36a in the axial direction (central longitudinal axis 14). The braking surface 36b is therefore mounted so that it can move in an axial direction relative to the main body 9.

The linear drive 24 therefore engages between the main body 9 and the second braking surface 36b and is driven in the axial direction. The linear drive 24 is therefore set up to move the second braking surface 36b in an axial direction (arrow 20) relative to the main body 9 against the brake disc 18 and thus to move the brake disc 18 in an axial direction against the first braking surface 36a.

Cooling conductors 40, here in the form of cooling channels, are integrated into the main body 9. In this case, these are each located in the vicinity of or in a thermal path for braking heat leading away from the respective first and second braking surfaces 36a. Further cooling conductors 40 are integrated in the counter-material disc 26. Heat generated by the frictional contact of the brake linings 22a, b on the braking surfaces 36a, b is dissipated or transferred via the cooling conductors 40 in the main body 9 or the housing 8 and the counter-material disc 26, which is indicated by arrows 42. The heat is conducted, for example, to a heat management system of the vehicle 2, which is not shown, where it is further processed or used.

The cooling conductor 40 is therefore thermally coupled to both braking surfaces 36a, b and is designed to dissipate heat generated during braking from the two braking surfaces 36a, b. The respective partial sections 48a of the cooling conductor 40 are embedded in the main body 9. The partial section 48a extends in the region of the first braking surface 36a, i.e., sufficiently close to the braking surface 36a to absorb as much heat as possible. However, it is far enough away to leave sufficient material thickness of the main body 9 so that it can permanently absorb the mechanical and thermal loads on the first braking surface 36a during braking. The partial section 48b of the cooling conductor 40 is arranged in a component of the linear drive 42, in this case the counter-material disc 26. Here too, the above applies to the arrangement “in the region” with regard to the compromise between thermal coupling and mechanical load capacity.

Due to a seal 44, the inner chamber 11 is sealed against brake dust (not shown) in relation to an exterior space 46 of the brake assembly 6. Brake dust is produced during braking processes, for example by abrasion of the brake linings 22a, b. This prevents brake dust from entering the environment or the exterior space 46 of the brake assembly 6. The seal 44 here is a radial shaft seal.

In FIG. 1, the brake linings 22a, b are therefore parts of the brake disc 18 and are designed to bear against the first and second braking surfaces 36a, b.

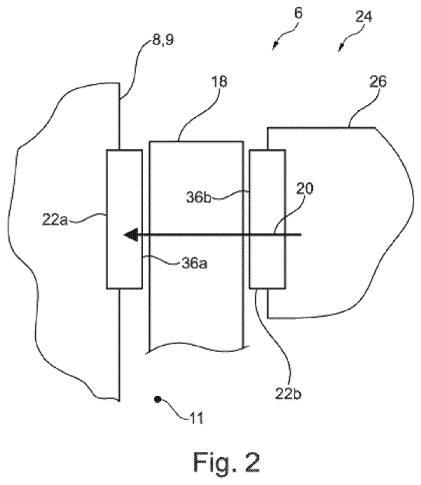

FIG. 2 shows an alternative variant or embodiment of the brake assembly 6. Here the brake linings 22a, b are not attached to the brake disc 18. An alternative brake lining 22a, on the other hand, is attached to the main body 9 or forms part of the main body 9. The first braking surface 36a is then formed by the surface of the brake lining 22a.

The brake lining 22b is attached to the counter-material disc 26 or forms a part of this counter-material disc 26. The second braking surface 36b is thus formed by the surface of the brake lining 22b. The brake disc 18 then comes into direct contact with the respective braking surfaces 36a, b (without itself having any brake linings).

In FIG. 2, the first brake lining 22a is therefore part of the main body 9 and forms the first braking surface 36a. The brake lining 22b has the second braking surface 36b and is part of the counter-material disc 26. This means that the counter-material disc 26 also has the second braking surface 36b.

### LIST OF REFERENCE SYMBOLS

2 Vehicle
4 Axis
6 Brake assembly
8 Housing
9 Main body
10 Shaft
11 Interior
12 Bearing
13 Connecting flange
14 Central longitudinal axis
15 Securing ring
16 Toothing
18 Brake disc
20 Arrow
22a, b Brake lining
24 Linear drive
26 Counter-material disc
28 Hydraulic cylinder
30 Drive
32 Guide
36a, b First, second braking surface
38 Surface
40 Cooling conductor
42 Arrow
44 Seal
46 Exterior space
48a, b Partial section (cooling conductor)

1. A brake assembly comprising:
having a housing enclosing an interior and having a main body,
a shaft mounted on the main body so as to rotate about a central longitudinal axis, extending at least partially in the interior and having a connecting flange for the shaft accessible on the outside of the housing,
a brake disc located in the interior and mounted on the shaft so as to be axially displaceable relative to the main body for conjoint rotation with respect to the central longitudinal axis,
wherein the main body has a first braking surface in the interior, against which the brake disc can be approached in the axial direction of the central longitudinal axis,
a second braking surface, which lies beyond the brake disc in the axial direction with respect to the first braking surface and is mounted so as to be movable in the axial direction with respect to the main body,
a linear drive which engages between the main body and the second braking surface, operates in the axial direction, and is set up to move the second braking surface in the axial direction relative to the main body against the brake disc and thus to move the brake disc in the axial direction against the first braking surface, and
a cooling conductor which is thermally coupled at least to both braking surfaces and which is designed to dissipate heat generated during braking at least from the two braking surfaces.

2. The brake assembly according to claim 1, wherein at least a partial section of the cooling conductor is embedded in the main body.

3. The brake assembly according to claim 1, wherein at least a partial section of the cooling conductor extends in the region of the first braking surface.

4. The brake assembly according to claim 1, wherein the first and/or the second braking surface extends completely annularly around the central longitudinal axis in the circumferential direction.

5. The brake assembly according to claim 1, wherein at least a partial section of the cooling conductor is arranged on a section of the linear drive that is movable relative to the main body.

6. The brake assembly according to claim 5, wherein at least a partial section of the cooling conductor is arranged on a counter-material disc of the linear drive having the second braking surface.

7. The brake assembly according to claim 1, wherein the linear drive is hydraulically actuated.

8. The brake assembly according to claim 1, wherein the housing is designed to be dust-tight in relation to an exterior space surrounding the housing with respect to any brake dust.

9. The brake assembly according to claim 1, wherein the main body is at least a part of the housing or vice versa.

10. The brake assembly according to claim 1, wherein the brake assembly contains at least one brake lining, wherein
at least one of the brake linings is a part of the main body and forms the first braking surface,
at least one of the brake linings has the second braking surface, and/or
at least one of the brake linings is a part of the brake disc and is arranged to bear against the first and/or the second braking surface.

11. A brake assembly comprising:
a housing enclosing an interior and having a main body;
a shaft mounted on the main body to rotate about a central longitudinal axis, extending at least partially in the interior and having a connecting flange for the shaft accessible on the outside of the housing;
a brake disc located in the interior and mounted on the shaft so as to be axially displaceable relative to the main body for conjoint rotation with respect to the central longitudinal axis, the main body including a first braking surface in the interior, against which the brake disc can be approached in the axial direction of the central longitudinal axis;
a second braking surface, which lies beyond the brake disc in the axial direction with respect to the first braking surface and is mounted so as to be movable in the axial direction with respect to the main body;
a linear drive which engages between the main body and the second braking surface, operates in the axial direction, and is configured to move the second braking surface in the axial direction relative to the main body against the brake disc to move the brake disc in the axial direction against the first braking surface, the linear drive being hydraulically actuated; and
a cooling conductor thermally coupled at least to both braking surfaces and is configured to dissipate heat generated during braking at least from the two braking surfaces, at least a partial section of the cooling conductor being embedded in the main body.

12. The brake assembly according to claim 1, wherein at least a partial section of the cooling conductor extends in the region of the first braking surface.

13. The brake assembly according to claim 1, wherein the first and/or the second braking surface extends annularly around the central longitudinal axis in the circumferential direction.

14. The brake assembly according to claim 1, wherein at least a partial section of the cooling conductor is arranged on a section of the linear drive and movable relative to the main body.

15. The brake assembly according to claim 14, wherein at least a partial section of the cooling conductor is arranged on a counter-material disc of the linear drive having the second braking surface.

16. The brake assembly according to claim 1, wherein the housing is configured to be dust-tight in relation to an exterior space surrounding the housing with respect to any brake dust.

17. The brake assembly according to claim 1, wherein the main body is at least a part of the housing.

18. The brake assembly according to claim 1, wherein the brake assembly contains at least one brake lining, wherein
at least one of the brake linings is a part of the main body and forms the first braking surface;
at least one of the brake linings has the second braking surface; and/or at least one of the brake linings is a part of the brake disc and is arranged to bear against the first and/or the second braking surface.

19. An electric vehicle comprising:
an axle; and
a braking assembly configured to brake the axle, the braking assembly comprising:
a housing enclosing an interior and having a main body;
a shaft mounted on the main body to rotate about a central longitudinal axis, extending at least partially in the interior and having a connecting flange for the shaft accessible on the outside of the housing;
a brake disc located in the interior and mounted on the shaft so as to be axially displaceable relative to the main body for conjoint rotation with respect to the central longitudinal axis,
wherein the main body has a first braking surface in the interior, against which the brake disc can be approached in the axial direction of the central longitudinal axis,
a second braking surface, which lies beyond the brake disc in the axial direction with respect to the first braking surface and is mounted so as to be movable in the axial direction with respect to the main body,
a linear drive which engages between the main body and the second braking surface, operates in the axial direction, and is configured to move the second braking surface in the axial direction relative to the main body against the brake disc to move the brake disc in the axial direction against the first braking surface; and
a cooling conductor thermally coupled at least to both braking surfaces and is configured to dissipate heat generated during braking at least from the two braking surfaces.

20. The electric vehicle according to claim 19, wherein at least a partial section of the cooling conductor is embedded in the main body.
